(19) United States
(12) Patent Application Publication
(10) Pub. No.: US 2019/0118212 A1
(43) Pub. Date: Apr. 25, 2019

(54) WATER FEATURE

(71) Applicant: Harald Bohlinger, Schwäbisch Gmünd (DE)

(72) Inventor: Harald Bohlinger, Schwäbisch Gmünd (DE)

(21) Appl. No.: 16/090,614

(22) PCT Filed: Apr. 2, 2017
(86) PCT No.: PCT/DE2017/100253

§ 371 Date: Oct. 2, 2018

(30) Foreign Application Priority Data
Apr. 5, 2016 (DE) 10 2016 106 227.8

(51) Int. Cl. B05B 17/08; B05B 9/03; B05B 9/04; B05B 12/00

(52) U.S. Cl. CPC B05B 17/08; B05B 12/00; B05B 9/0406; B05B 9/035

(57) ABSTRACT

A water feature includes a plurality of pump systems and an input and control device configured to control each of the pump systems. Each pump system is arranged in a pump field, is connected to a water supply and includes a jet nozzle and an electrically powered pump. Each jet nozzle emits a water jet that is propelled by the corresponding pump to an individual jet height or distance. Control signals generated by the input and control device are saved in non-volatile form in a storage element. The jet height or distance for each water jet is determined by the pump performance as regulated by the input and control device. A view of upper ends of the water jets gives the impression of a virtual., spatially perceptible object.

### CROSS-REFERENCE TO RELATED APPLICATION

The present application is a Section 371 National Stage Application of and claims priority of International patent application Serial No. PCT/DE2017/100253, filed Apr. 2, 2017, and published as WO 2017/174068 in German, the content of which is here-by incorporated by reference in its entirety.

### FIELD

The invention describes a water feature for creating a representational spatial impression of any object, visible to a human observer, consisting of the total impression of the height of multiple water jets.

### BACKGROUND

Water features realised using jets of water or fountains have existed for centuries. Technical solutions for such features are mostly aimed at optimising jet form, direction and distance, and arranging water jets into water features. For example, the German utility model specification DE 20 2015 000 215 U1 “Water game with continuous jet path” describes a device which uses jet guidance fixed in advanced for each use case. The special sequence generated by the water jets created is supposed to provide the observer with the association of a generally well known object/symbol, for example a Christmas tree (an example explicitly listed in the patent), the ‘trunk’ of which is symbolised by a vertical pipe with several side openings which each produce jets of water that, in turn, are supposed to be viewed as ‘branches’. However, the downside of this technical solution is that only one object can be represented, due to the position of the openings from which the water comes, which are set during the initial installation and cannot be changed, i.e. in the example above the water feature will only ever represent a Christmas tree.

### SUMMARY

Embodiments of the present disclosure operate to create an improved water feature without such hydromechanical limitations, which can represent any number of different, symbolic spatial objects using jets of water.

This goal is accomplished by the disclosed embodiments using a water feature with the features of Claim 1. Advantageous variations can be taken from the embodiments recited in the accompanying dependent claims.

Unlike the utility model described above (Water game with continuous jet path), the present disclosure includes embodiments that take a completely different approach to convey a completely new type of visual water feature experience. In some embodiments, the water feature is not configured to be perceived by a human observer in an isolated state as individual fountains or water jets, but rather as a three dimensional object made up of the total impression created by the water jet peaks, i.e. the reversal point of the shooting water outlining a two or three dimensional model.

Many types of fountains and jet systems are known from the state of the art. However, these systems cannot produce the effect described above of a closed optical-spatial perception of a three dimensional body of water, as they each more or less only emit water jets that are perceived individually. There is as yet nothing similar to the present approach of a combination based on a jet field consisting of multiple jet nozzles installed in a very close meshed net and in which the height of each individual jet emerging from a jet nozzle can be influenced individually via digital controls using an IT unit. In this manner, spatially observable figures and any three dimensional item can be virtually modelled using water only, although in a preferred, additional model of this new, closed visual spatial impression the illusion will be strengthened effectively and in various ways as the body of water will be connected to illumination provided by lighting elements also grouped very closely to the jet axes.

The effect described above becomes more plastic and realistic the higher the number of jet nozzles and therefore jet streams there are, because the eye, similar to other imaging techniques, is able to recognize a flat or three dimensional context easier when there are a higher number of elements used to depict it per unit area, i.e. the higher the resolution. Which is why the invention is based on an additional feature of a maximum distance of 100 mm from the middle axis of the jet nozzles built on the jet field to one another, and of 60 mm from the light elements grouped around a jet nozzle from the jet nozzle middle axis. In accordance with the previous state of the art, due to suitable pump systems only being available in larger dimensions, only larger distances were possible, and lighting rings for installation in connection with water feature jet nozzles were also only available with a diameter of at least 300 mm.

Embodiments of the present disclosure are also very advantageous as compared to the previous state of the art as the form of the item modelled by the fountain system may not only represent a fixed object, but can also be changed as desired over the course of time. Therefore, it is not just spatial models that can be represented, but also dynamically changing forms, so that an object just created as a virtual body of water can, a few moments later, transform into a completely new item. Associated changes to lighting can significantly strengthen the impression given when using the illuminated model. Similarly, for example, a three dimensional landscape model can be simulated using water, the shape of which changes just like that of the two dimensional picture created in a flight simulator that is constantly transforming to reflect the terrain being flown over.

Additional advantages and features can be taken from a practical example of the invention described in the following.

### BRIEF DESCRIPTION OF THE DRAWINGS

FIG. 1 an individual pump system in a perspective view, in accordance with embodiments of the present disclosure.

FIG. 2 a pump field from the present invention, set as a jet field, in which, for example, 100 pump systems are brought together, with a view from above, in accordance with embodiments of the present disclosure.

FIG. 3 a pump field from FIG. 2 in a perspective view, in accordance with embodiments of the present disclosure.

FIG. 4 an application example, the contours of a face as a virtual three dimensional object, in accordance with embodiments of the present disclosure. Its spatially perceptible impression is created from the sum total of the top end of the water jets.

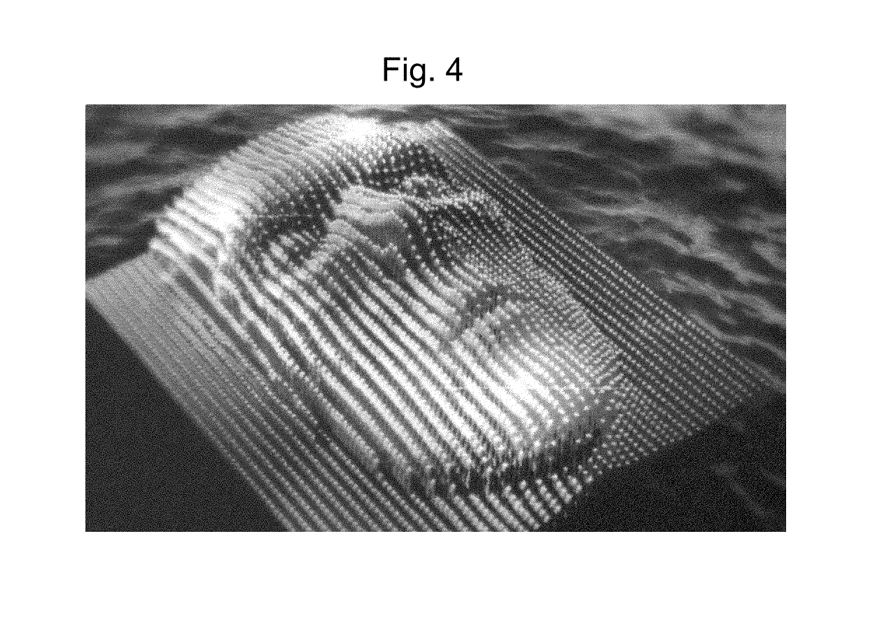

### DETAILED DESCRIPTION OF THE ILLUSTRATIVE EMBODIMENTS

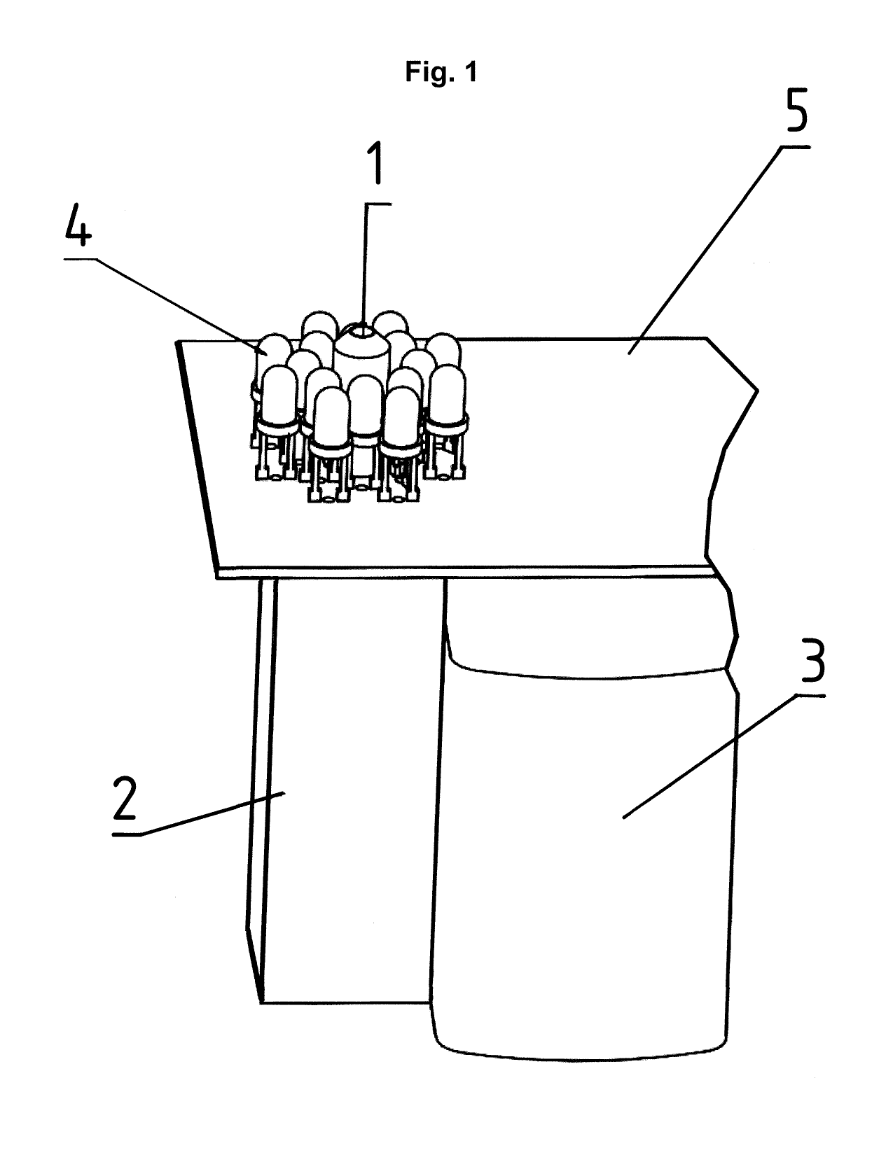

In the pump system connected to a water supply (FIG. 1), an electrically run and pressure regulated pump 3 creates the water pressure required for creation of a water jet. After leaving pump 3, the water, under operating pressure that can be regulated, runs through a (not functionally required for the present invention) laminar flow generator 2, which prepares the flow of the water jet. Connected to the laminar flow generator 2 is at least one jet nozzle 1, from which the water emerges when the device is in operation. The jet nozzle 1 can, using a support element 5 preferentially designed as a circuit board, be installed either fixed and vertical to the support element or, in an additional model, in an angle deviating from vertical to the support element 5 that can be adjusted and individually rotated and pivoted.

Not functionally required for the invention, but preferred in an additional model, at least one or several light elements 4 can be positioned immediately next to the jet nozzle 1 to illuminate the emerging water jet. Due to their specific low sensitivity to moisture and low energy use, the preferred light elements would be light diodes (LED) and/or semiconductor lasers (laser diode) with one or more colours. To protect them from damp, the light element connections and the circuit boards (support element 5) can be water-proofed in the manner known to experts by filling with a casting compound (not visually represented).

For the jet nozzle 1, depending on the intended purpose, various options may be used, known to experts and able to turn and pivot on both axes, in order to create various jet forms and achieve variable heights for the water jets emerging from them. Thus, in addition to jet nozzles that create a closely knit linear jet, the invention could also use jet nozzles that spread water more broadly, such as (partial) circular jet nozzles or jet nozzles that generate a film of flat water. In this manner, predominantly in fountain fields run statically, in which no continuous change in shape is planned for the symbol represented by the water, various jet nozzle types can be used to generate special effects, or, for example, to create desired turbulence with jet nozzles next to the fountains.

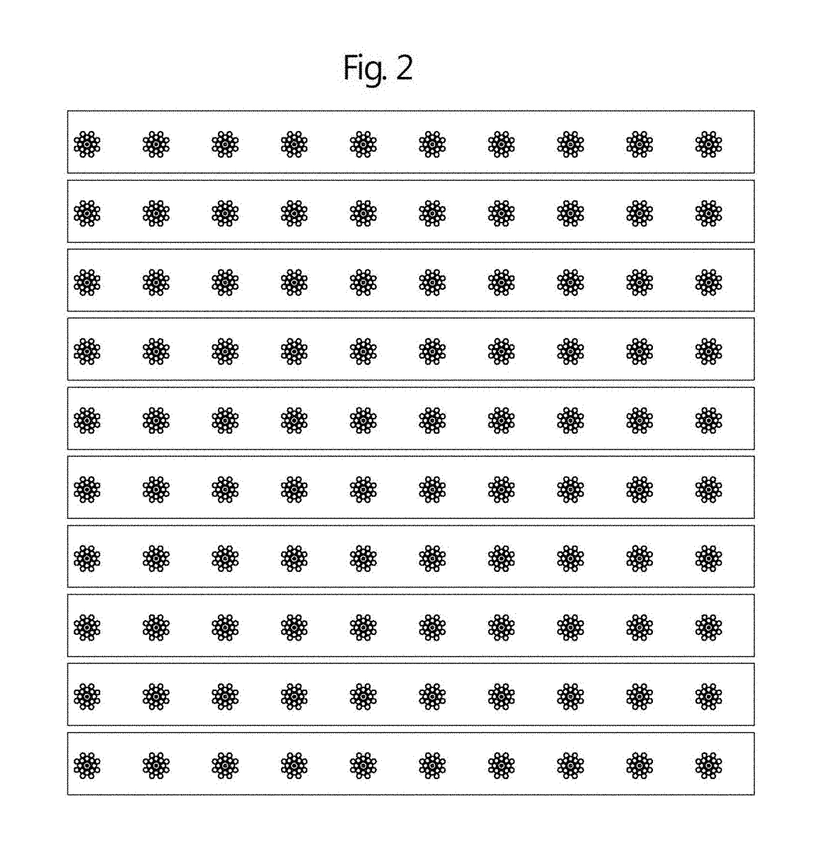

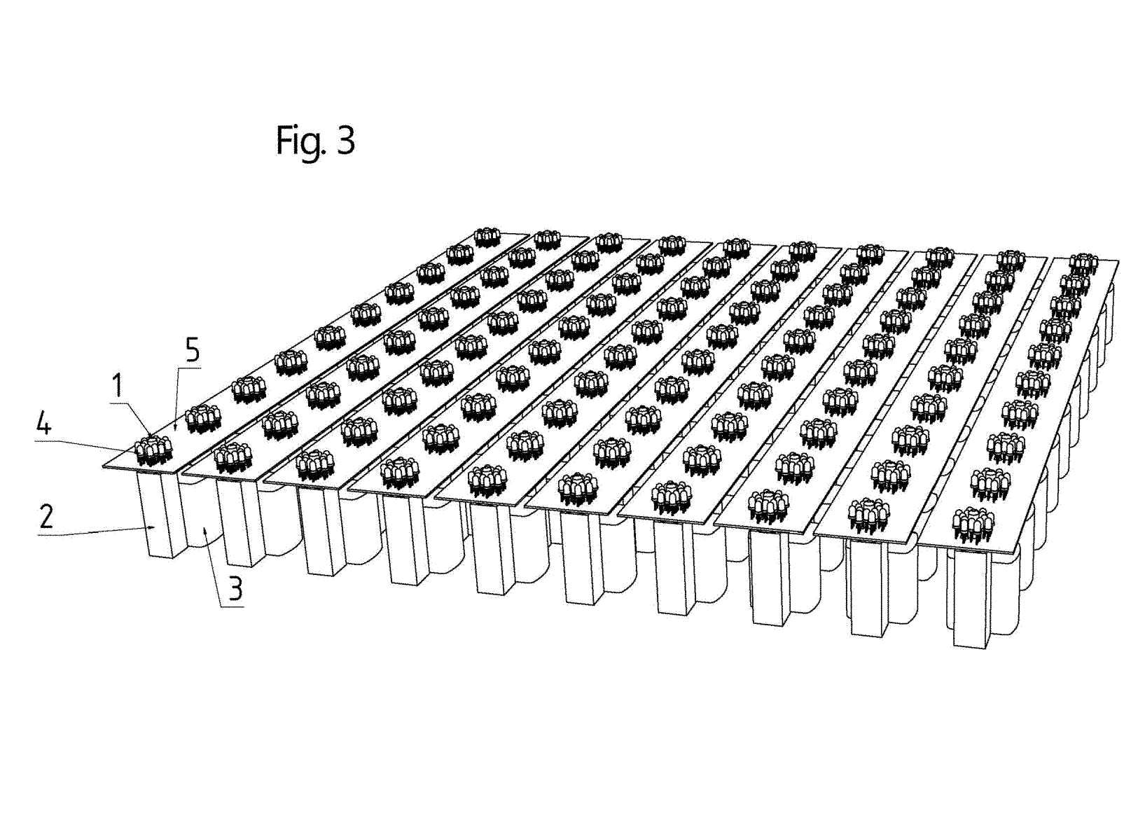

In the event that, in an additional model, moveable jet nozzles 1 are used in the pump field (FIGS. 2 and 3), effects similar to those described in the previous paragraph can be achieved provided that these nozzles are set to create jets in a different direction to those fixed nozzles that are set next to them and shoot parallel water jets.

Past experiences have shown the production of disorganised turbulence immediately after the water is released from the jet nozzle, which is undesirable from an optical and energy perspective, can be reduced in water feature and fountain systems if the water is, before exiting, focused into laminar flows. This is achieved using the laminar flow generator 2, which directs the flow pattern using a damping element and therefore significantly improves the water flow behaviour after it emerges from the jet nozzle. The damping element could, for example, be a metal mesh known to experts and designed to optimise laminar flow. An advantageous side effect is that the use of a laminar flow generator noticeably increases the jet height without the need for increased energy.

The pump field from the present invention (FIGS. 2 and 3) consists of combining any desired number of pump systems (FIG. 1) in any order. A square arrangement of the pump systems, as seen in the examples in FIGS. 2 and 3, is not required. Several pump fields can also be connected in a modular manner The pump field is, preferably, laid out horizontally, so that the jet stream emerging from fixed jet nozzles goes directly upwards. However, the pump field can also be installed at an angle, particularly if the pump systems have moveable jet nozzles and different jet distances are to be realised to create particular optical effects. The pump field is water proof overall (protection class IP68 can be realised technically without any additional effort), allowing for use above and also below the surface of the water.

The pump regulation (not depicted visually) is, in the present invention, carried out using a suitable input and control device (computer technology with relevant control software). This is done by ensuring each pump system within the pump field is individually controlled and regulated independent of the other pump systems within the pump field using a suitable digital control protocol, preferably the Digital Multiplex Protocol (DMX) already established in stage and event technology for controlling lighting effects. This provides fine granular calibration for the pump speed and therefore the jet height of each individual pump system via one or more channels from the bus system in use in one or more steps. Typically an 8 bit resolution is used, which produces 255 steps. If necessary, a 16 bit resolution can also be used, with over 65,000 steps.

In order to realise the pump regulation described above, the input and control device (for example a laptop with control software) is used to generate a control signal which is sent to a microcontroller which contains at least one processor and has at least one suitable interface for the control protocol required for communication between the input and control device and the pump field.

The microcontroller processes the signal received from the input and control device, and generates as part of D/A conversion or pulse-width modulation (PWM) one or more new signals to at least one downstream driver stage which can be run as a power amplifier (e.g. MOSFET) and in turn provides an analogue or PWM electricity supply and speed control for the pump system.

In the present invention, in a similar manner, the light control in the additional illuminated model can also take place using a power amplifier (e.g. MOSFET); in this case the electricity supply and brightness regulation can also be realised using PWM. In this way, each individual light element 4 can, via additional bus system channels available as part of the control protocol in use, be controlled and graduated as desired using every available brightness step (0-100%) and colour option (up to 16.8 million colours).

Required for the function and included in the present invention is, in addition, a storage element for saving the control signal generated by the input and control device and/or the reported status information sent from the pump field or its pumps and, if necessary, the light elements to non-volatile memory. An assignment table is saved in the storage element containing all commands transferred from the input and control device for speed regulation of pump systems and, in the case of the illuminated additional model, for light regulation as well as status information for pump systems and light elements, provided said elements are technically prepared for and capable of sending feedback on their status information.

In some embodiments, a bidirectional exchange of status information is performed using Remote Device Management (RDM).

Use of an RDM simultaneously provides the option of manual or automatic (fine) calibration.

Although embodiments of the present disclosure have been described with reference to preferred embodiments, workers skilled in the art will recognize that changes may be made in form and detail without departing from the spirit and scope of the present disclosure.

1. A water feature comprising:
a plurality of pump systems, each pump system being connected to a water supply and including a jet nozzle and a pump that is electrically powered; and
an input and control device configured to control each of the pumps;
wherein:
the pump systems are arranged in a pump field;
each jet nozzle emits a water jet propelled by the corresponding pump to an individual jet height or distance;
control signals generated by the input and control device are saved in a non-volatile form in a storage element;
the jet height or distance for each water jet is determined by the pump performance as regulated by the input and control device; and
a view of upper ends of the water jets gives the impression of a virtual, spatially perceptible object.

2. The water feature in accordance with claim 1, wherein the input and control device is configured to regulate the pumps to form multiple and various virtual, spatially perceptible three dimensional objects represented by the upper ends of the water jets, and adjust the form of the objects represented by the upper ends of the water jets over time.

3. The water feature in accordance with claim 1, wherein at least one of the jet nozzles is configured to turn and pivot on dual axes.

4. The water feature in accordance with claim 1, wherein each pump system includes a device located between the pump and the jet nozzle designed to create a laminar flow in the water emerging from the jet nozzle.

5. The water feature in accordance with claim 1, wherein at least one support element is connected to each pump system, and the at least one support element includes a light element.

6. The water feature in accordance with claim 1, wherein digital control of the pump is carried out using a Digital Multiplex Protocol (DMX).

7. The water feature in accordance with claim 1, wherein at least one light element is located adjacent to each of the jet nozzles.

8. The water feature in accordance with claim 7 wherein each of the at least one light element includes a light emitting diode.

9. The water feature in accordance with claim 7, wherein each of the at least one light element includes a semiconductor laser or laser diode.

10. The water feature in accordance with claim 1, wherein the at least one light element is digitally regulated using at least one of the following: a control protocol used by an input and control device, a microcontroller, an element for non-volatile memory storage and at least one power amplifier.

11. The water feature in accordance with claim 1, wherein an exchange of status information between the input and control device and the pump system is carried out bidirectionally using Remote Device Management (RDM).

12. The water feature in accordance with claim 7, wherein an exchange of status information between the input and control device and the at least one light element is carried out bidirectionally using Remote Device Management (RDM).
